(19) United States
(12) Patent Application Publication
(10) Pub. No.: US 2004/0184613 A1
(43) Pub. Date: Sep. 23, 2004

(54) Method of safely sending e-mails over LAN

(75) Inventors: Cheng-Shing Lai, Taipei Hsien (TW); Yi-Jung Wu, Nanking (CN); Shuang-Jun Xu, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsien (TW)

(21) Appl. No.: 10/388,648

(22) Filed: Mar. 17, 2003

(51) Int. Cl. H04K 1/00

(52) U.S. Cl. 380/249

(57) ABSTRACT

The present invention is to provide a method of safely sending encrypted e-mails over LAN comprising the steps of installing a LAN access program on a wireless communication device; connecting the wireless communication device to a LAN; setting LAN access conditions in the LAN access program prior to sending e-mail; and enabling a CPU of the wireless communication device to perform the sub-steps of performing an authorization at a server based on the LAN access conditions; after gaining the authorization, adding corresponding encrypted codes on the e-mail based on a selected safety level; and sending the encrypted e-mail over an authorized VPN.

### FIELD OF THE INVENTION

The present invention relates to LAN (local area network) and more particularly to a method of sending encrypted e-mails over the LAN with improved safety quality.

### BACKGROUND OF THE INVENTION

Over the past several decades there has been a simultaneous growth in information technology and electronics, leading to an increasing use of electronic, mobile communication, and network products. Increasingly, more and more compact, multi-functional, and inexpensive mobile communication products are commercially available and very popular. For example, cellular phones and PDAs (Personal Digital Assistants) are closely related to our daily life and work. Their increasing popularity shortens time required for communicating between two distant users. In addition, people have an increasing demand to the quality of the mobile communication products as they are available in an even faster pace. Thus, a leading indicator of one mobile communication product can be decided based on whether it can provide a more convenient service, a more effective operation, and more features.

Increasingly, many cellular phones are able to send and receive e-mails and connect to the Internet or a network (e.g., LAN). Hence, a user can use his/her cellular phone to connect to the Internet or the LAN to retrieve latest information without being adversely affected by geography, buildings, or location. However a conventional cellular phone does not have a safety mechanism. Hence, an unauthorized person may easily invade into the LAN interconnected a company and an individual who is sending or receiving e-mails containing confidential documents or sending e-mails containing confidential documents to the company over the LAN by means of cellular phone. As an end, the confidential e-mails are intercepted by the unauthorized person, resulting in a great loss to the individual.

Thus, it is desirable among mobile communication product manufacturers to provide a cellular phone having e-mail encryption mechanism and enable a cellular phone user to perform a method to send or receive encrypted e-mails to or from his/her company over the LAN at any time, place without being adversely affected by geography, buildings, or location.

### SUMMARY OF THE INVENTION

A primary object of the present invention is to provide a method of sending encrypted e-mails over a LAN by means of a communication device so that an unauthorized person cannot intercept and browse the sent e-mails by means of an unauthorized wireless communication device. By utilizing this method, the above drawback of the prior art, i.e., an unauthorized person may easily invade into the LAN interconnected a company and an individual who is sending or receiving e-mails containing confidential documents or sending e-mails containing confidential documents to the company over the LAN by means of cellular phone. As an end, the confidential e-mail intercepted by the unauthorized person, resulting in a great loss to the individual, can be overcome.

To achieve the above and other objects, the present invention provides in a wireless communication device a method of safely sending an e-mail over a LAN comprising the steps of installing a LAN access program on the wireless communication device; connecting the wireless communication device to the LAN; setting LAN access conditions in the LAN access program prior to e-mail sending; and enabling a CPU of the wireless communication device to perform the sub-steps of performing an authorization at a server based on the LAN access conditions; after gaining the authorization, adding corresponding encrypted codes on the e-mail based on a selected safety level; and sending the encrypted e-mail over an authorized VPN. As an end, a purpose of e-mail protection during sending is achieved.

The above and other objects, features and advantages of the present invention will become apparent from the following detailed description taken with the accompanying drawings.

### BRIEF DESCRIPTION OF THE DRAWINGS

FIG. 1 presents schematically the connection of wireless communication device and server according to the invention;

FIG. 2 is a block diagram showing components of the server;

FIG. 3 is a flow chart showing a sequence of steps performed by the server;

FIG. 4 is a block diagram showing components of push server according to the invention; and

FIG. 5 is a block diagram showing components of manager server according to the invention.

### DETAILED DESCRIPTION OF THE PREFERRED EMBODIMENTS

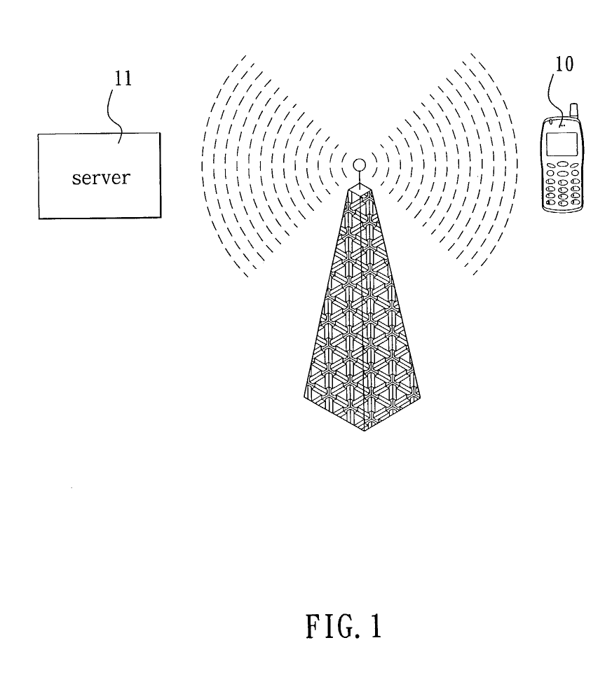

The invention is directed to a method of safely sending an e-mail over a LAN. Referring to FIG. 1, the method is implemented on a wireless communication device (e.g., cellular phone or PDA) 10 which has an installed LAN access program. A cellular phone user is then able to use the wireless communication device 10 to connect to the LAN. Next, the user can set LAN access conditions prior to sending e-mails. A CPU (central processing unit) of the wireless communication device 10 is able to connect to the LAN based on the LAN access conditions prior to performing an authorization at a server 11. After gaining the authorization, the user can add corresponding encrypted codes on the e-mail based on a selected safety level. As a result, the encrypted e-mail can be sent over an authorized VPN (Virtual Private Network).

Referring to FIG. 1 again, in the invention the user can select a format of informing from the server 11. As such, the server 11 may send a message to the user based on the format of informing prior to sending an e-mail to the wireless communication device 10. Next, the user can set the LAN access conditions in the LAN access program. The CPU then is able to connect to the LAN based on the LAN access conditions prior to performing the authorization at the server 11. After gaining the authorization, the user can add corresponding encrypted codes on the e-mail based on the selected safety level. As such, the encrypted e-mail can be sent from the server 11 to the wireless communication device 10 over the authorized VPN. As an end, it is possible of preventing an unauthorized person from intercepting and browsing the sent e-mail by means of an unauthorized wireless communication device 10. As a result, a purpose of e-mail protection during sending is achieved.

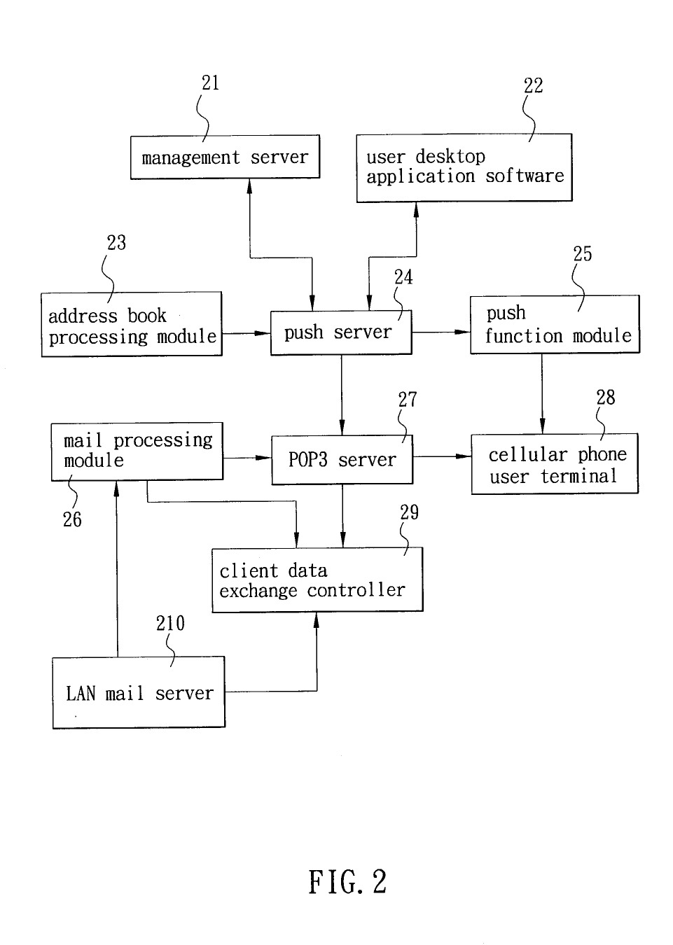

Referring to FIGS. 1 and 2, in a preferred embodiment of the invention, the server 11 comprises a management server 21, a user desktop application software 22, an address book processing module 23, a push server 24, a push function module 25, a mail processing module 26, a POP3 (Post Office Protocol 3) server 27, a cellular phone user terminal 28, a client data exchange controller 29, and a LAN mail server 210. The management server 21 is responsible for managing the push server 24, a push user list, set information of respective users, and message or e-mail sending about an individual or group. The user desktop application software 22 enables a user to set e-mail push services and set new e-mail informing filter information by interacting with the push server 24. The address book processing module 23 is a part of a POP3 server 27. The address book processing module 23 can access global directory from the LAN mail server 210 and send it to the push server 24. The push server 24 gains an address book from the POP3 server 27 and vice versa. Both the push server 24 and the POP3 server 27 send e-mails, collect user new e-mail information required for push service, and send out information via the push function module 25 which is a part of the push server 24. The push function module 25 sends new e-mail information set by user to the wireless communication device 10 at the user by referring to an IP (Internet Protocol) address set by the user. The mail processing module 26 is a POP3 service program and is interacted with the push server 24, sends e-mails to the client data exchange controller 29, and is interacted with the wireless communication device 10 such as Web page browsing, network information downloading, network data deletion, etc. The POP3 server 27 comprises the address book processing module 23 and the mail processing module 26. The POP3 server 27 is also interacted with the cellular phone user terminal 28 and the client data exchange controller 29. The cellular phone user terminal 28 can support WAP (Wireless Application Protocol) and GPRS (General Packet Radio Service). The client data exchange controller 29 is a desktop application software for sending or receiving e-mails such as Microsoft Outlook or Foxmail. The client data exchange controller 29 may send or receive e-mails from user by using POP3 and SMTP (Simple Mail Transport Protocol).

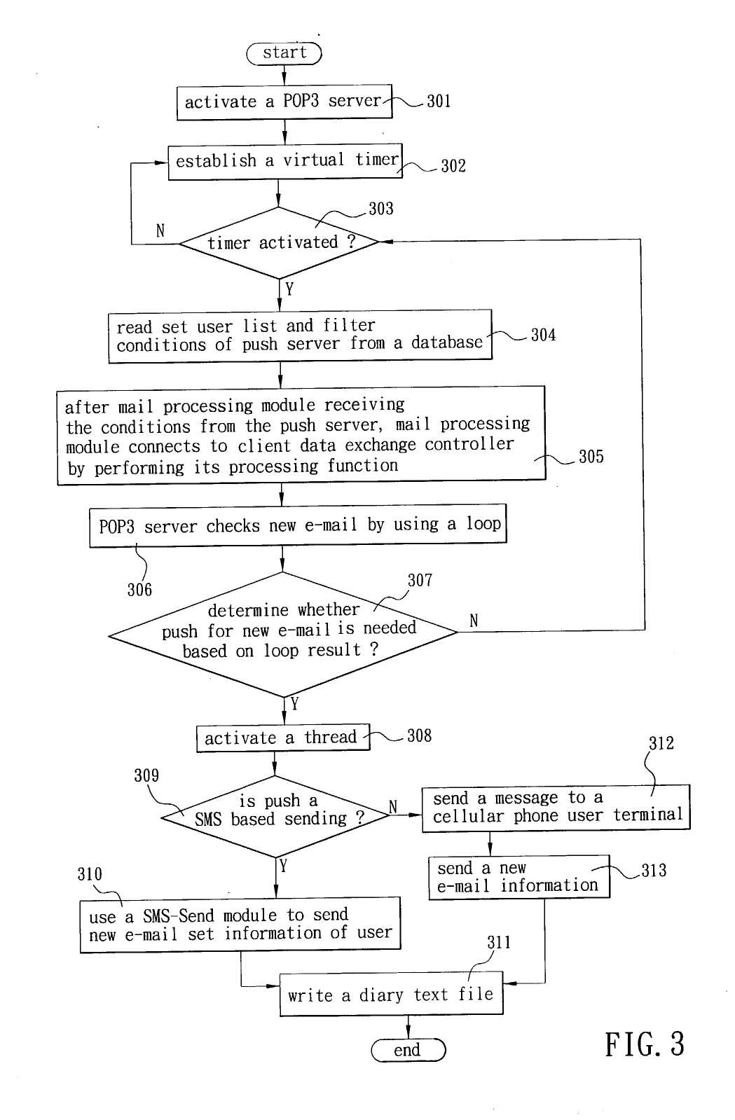

Referring to FIG. 3 in conjunction with FIGS. 1-2, there is shown a flow chart showing a sequence of steps performed by the server 11 for connecting to and interacting with the wireless communication device 10. Beginning in step 301, the push server 24 activates and enables the POP3 server 27 to detect via a port. Further, activates a new thread to connect to and interact with a user if there is no connection between the user and the wireless communication device 10. In step 302, the push server 24 establishes a virtual timer which regularly sends set user list and filter conditions of the push server 24 to the POP3 server 27. The set user list and the filter conditions of the push server 24 are accessed from a database. In step 303, the push server 24 determines whether the timer is activated. If yes, the process proceeds to step 304. Otherwise, the process loops back to step 302. In step 304, the push server 24 reads the set user list and the filter conditions (e.g., sender, importance, etc.) thereof from the database and sends the same to the POP3 server 27. In step 305, after the mail processing module 26 receiving the conditions from the push server 24, the mail processing module 26 connects to the client data exchange controller 29 by performing its processing function. In step 306, the POP3 server 27 checks whether there is a new e-mail by using a loop and determines whether a push for the new e-mail is needed by observing the filter conditions of the push server 24. If push data is necessary, sends the push data to the push server 24. In step 307, the push server 24 determines whether a push is needed by checking a loop result. If push data is needed, the process proceeds to step 308. Otherwise, the process loops back to step 303. In step 308, the push server 24 activates a thread. In step 309, the push server 24 reads a push set by user from the database and determines whether the push is a SMS (Short Message Service) based sending. If yes, the process proceeds to step 310. Otherwise, the process jumps to step 312. In step 310, the push server 24 uses a SMS-Send module to send new e-mail set information of user. In step 311, the push server 24 writes a diary text file and the process ends immediately. In step 312, the push server 24 sends a message of informing to the wireless communication device 10 at the user based on a set format and waits the set conditions. Next, the push server 24 adds corresponding encrypted codes on the e-mail based on a selected safety level. As a result, the encrypted e-mail can be sent over the authorized VPN. In step 313, the push server 24 sends a new e-mail information prior to going back to step 311.

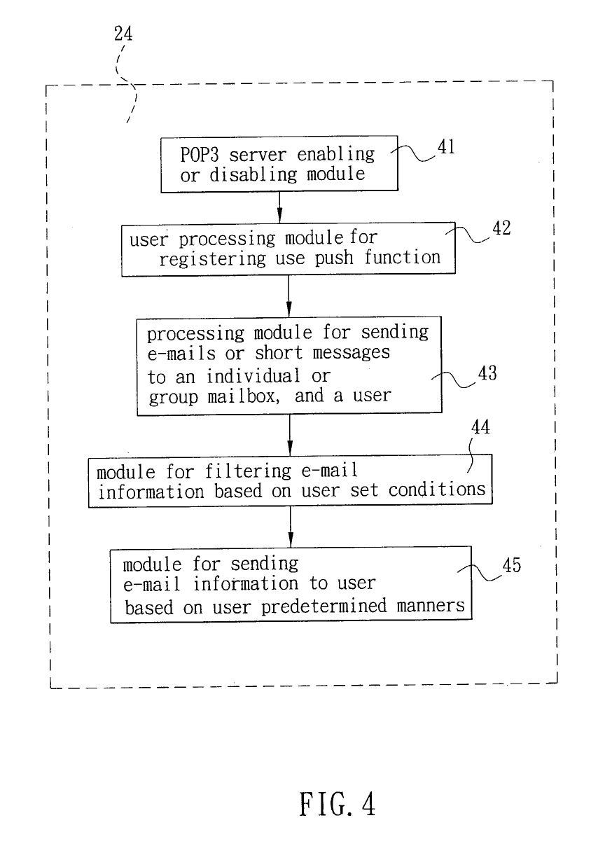

Referring to FIG. 4, the push server 24 comprises a POP3 server enabling or disabling module 41, a user processing module 42 for registering use push function, a processing module 43 for sending e-mails or short messages to an individual or group mailbox, and a user, a module 44 for filtering e-mail information based on user set conditions, and a module 45 for sending e-mail information to user based on user predetermined manners.

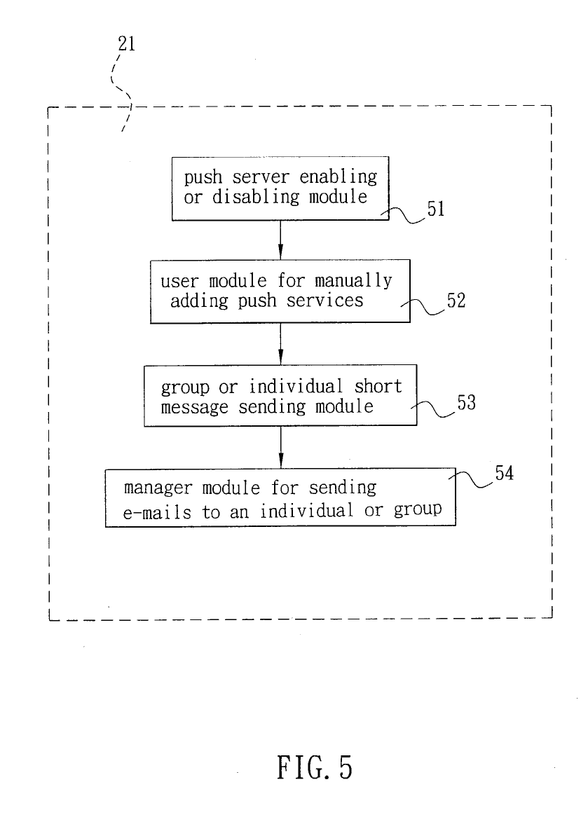

Referring to FIG. 5, the management server 21 comprises a push server enabling or disabling module 51, a user module 52 for manually adding push services, a group or individual short message sending module 53, and a manager module 54 for sending e-mails to an individual or group.

While the invention has been described by means of specific embodiments, numerous modifications and variations could be made thereto by those skilled in the art without departing from the scope and spirit of the invention set forth in the claims.

What is claimed is:

1. In a wireless communication device a method of safely sending an e-mail over a LAN comprising the steps of:
installing a LAN access program on the wireless communication device;
connecting the wireless communication device to the LAN;
setting LAN access conditions in the LAN access program prior to e-mail sending; and
enabling a CPU of the wireless communication device to perform the sub-steps of:
performing an authorization at a server based on the LAN access conditions;
after gaining the authorization, adding corresponding encrypted codes on the e-mail based on a selected safety level; and
sending the encrypted e-mail over an authorized VPN.

2. The method of claim 1, further comprising the steps of:
selecting a format of informing from the server;
sending a message to a user based on the format prior to sending the e-mail to the wireless communication device;
setting the LAN access conditions in the LAN access program;
enabling the CPU to connect to the LAN based on the LAN access conditions;
performing the authorization at the server;
after gaining the authorization, add corresponding encrypted codes on the e-mail based on the selected safety level; and
sending the encrypted e-mail from the server to the wireless communication device over the authorized VPN.

3. The method of claim 2, wherein the server comprises a push server including a POP3 server enabling or disabling module, a user processing module for registering use push function, a processing module for sending e-mails or short messages to an individual or group mailbox and a user, a first module for filtering e-mail information based on user set conditions, and a second module for sending e-mail information to user based on user predetermined manners; and a management server including a push server enabling or disabling module, a user module for manually adding push services, a group or individual short message sending module, and a manager module for sending e-mails to an individual or group.

4. The method of claim 1, wherein the wireless communication device is a cellular phone.
